(19) United States
(12) Patent Application Publication
(10) Pub. No.: US 2022/0331874 A1
(43) Pub. Date: Oct. 20, 2022

(54) RECONDITIONING USED BUILD MATERIAL POWDER FOR A 3D PRINTER

(71) Applicant: Hewlett-Packard Development Company, L.P., Spring, TX (US)

(72) Inventors: Jorge Diosdado Borrego, Barcelona (ES); Sergio Puigardeu Aramendia, Sant Cugat del Valles (ES); Sergi Culubret Cortada, Sant Cugat del Valles (ES)

(21) Appl. No.: 17/231,756

(22) Filed: Apr. 15, 2021

(51) Int. Cl. B22F 10/73; B33Y 40/00; B33Y 30/00; B33Y 10/00; B22F 10/10; B22F 12/55; B22F 12/58; B22F 1/00; B22F 12/10

(52) U.S. Cl. CPC B22F 10/73; B33Y 40/00; B33Y 30/00; B33Y 10/00; B22F 10/10; B22F 12/55; B22F 12/58; B22F 1/0059; B22F 12/10; B22F 1/0085

(57) ABSTRACT

In one example, a system for loading a build material powder supply receptacle for a 3D printer includes a reconditioner having a container and a heater to burn unwanted residue from used build material powder in the container, to form reconditioned build material powder, a conveyor operatively connected to the reconditioner to convey used build material powder to the container, and a dispenser operatively connected to the reconditioner to dispense reconditioned build material powder from the container into the supply receptacle.

### BACKGROUND

3D printers convert a digital representation of an object into a physical object. 3D printing includes any of various processes in which material is bound or solidified under computer control to create a three-dimensional object. 3D printing is also commonly referred to as additive manufacturing. 3D printers are often used to manufacture objects with complex geometries using materials such as thermoplastics, polymers, ceramics and metals. In powder based 3D printing, successive layers of a powdered build material are formed and portions of each layer bound or fused in a desired pattern to build up the layers of the 3D object.

### DRAWINGS

FIG. 1 illustrates an example system for loading build material powder into a supply receptacle for a 3D printer.

FIG. 2 illustrates an example system for recycling build material powder for a 3D printer.

FIG. 3 illustrates an example loading station for loading build material powder into a supply receptacle for a 3D printer.

FIG. 4 illustrates an example system for recycling build material powder for a 3D printer, that includes a loading station from FIG. 3.

FIG. 5 illustrates another example system for recycling build material powder fora 3D printer, that includes a loading station from FIG. 3.

FIG. 6 illustrates an example process for loading build material powder into a supply receptacle for a 3D printer.

The same part numbers designate the same or similar parts throughout the figures. The figures are not necessarily to scale.

### DESCRIPTION

Metal objects may be printed by selectively applying a liquid binder to portions of each of successive layers of metal powder to bind together those portions of the powder corresponding to the solid layer of the object. The binder is cured, for example using heat and/or ultra violet energy. The cured object, known commonly as a “green part”, is heated in a sintering furnace to fuse the metal particles to form the final object. Polymer objects may be printed by selectively applying a liquid fusing agent to portions of each of successively layers of polymer powder and exposing the treated powder to electromagnetic radiation, causing the treated powder to fuse the polymer particles.

Some of the powder used while printing an object may cling to the printed object. The process of removing powder from 3D printed objects is commonly referred to as “depowdering” or “decaking.” Depowdering techniques include vacuuming, vibrating, brushing and air blasting. Used build material powder collected from depowdering may be recycled to the 3D printer. It may be desirable to recondition used powder before reuse by burning any binder or fusing agent that remains in the used powder. Reconditioning is particularly desirable to recycle metal powders which are more expensive than polymer powders and may not be suitable for re-use without removing binder residue.

Currently, used metal powder is collected in batches at the depowdering station and each batch manually transferred to an oven to burn binder residue. The reconditioned powder is then manually transferred from the oven to a loading station for loading into a supply receptacle for a 3D printer. A new technique has been developed to help streamline the process of reconditioning metal and other used build material powders. In one example, a reconditioning process includes pumping or otherwise conveying used build material powder automatically from a depowdering station to the loading station, burning unwanted residue from the used build material powder at the loading station, to form reconditioned build material powder, and loading the reconditioned build material powder into a supply receptacle for a 3D printer.

The process may be implemented, for example, through a loading system that includes a reconditioner with a container and a heater to burn unwanted residue from used build material powder in the container, a pump to pump used build material powder to the container, and a dispenser operatively connected to the reconditioner to dispense reconditioned build material powder from the container into a supply receptacle. If desired, reconditioned powder may be mixed with fresh powder at the loading station for dispensing into the supply receptacle. In some examples, the used powder is pumped directly from the depowdering station to the reconditioning container at the loading station. In some examples, used powder is pumped to the reconditioning container as the used powder is vacuumed away from objects in the depowdering chamber. In other examples, a quantity of used powder is collected in a tank at the depowdering station and then pumped from the collection tank to the reconditioning container at the loading station.

Reconditioning used build material powder at the loading station eliminates batch processing in a separate reconditioning oven at a remote location and reduces the number of times the powder is handled from depowdering to loading. In addition, pumping used powder directly from the depowdering chamber to a reconditioner at the loading station avoids the time and expense of manually transporting the powder from depowdering to reconditioning to loading.

These and other examples described below and shown in the figures illustrate but do not limit the scope of the patent which is defined in the Claims following this Description.

As used in this document, “and/or” means one or more of the connected things; “burn” means to remove by heating; a “computer readable medium” means any non-transitory tangible medium that can embody, contain, store, or maintain information and instructions for use by a processor and may include, for example, circuits, integrated circuits, ASICs (application specific integrated circuits), hard drives, random access memory (RAM), read-only memory (ROM), and flash memory; and “powder” means consisting of small particles, including powder with clumps, for example caused by residue among the particles in used build material powder.

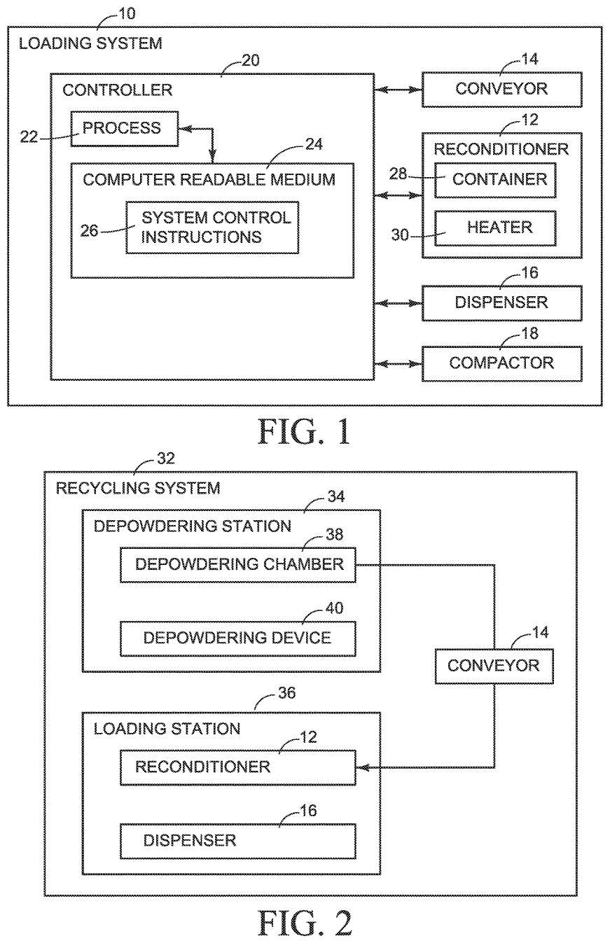

FIG. 1 illustrates an example system 10 for loading build material powder into a supply receptacle for a 3D printer. Loading system 10 in FIG. 1 may be integral to the printer or part of a loading station separate from the printer. Referring to FIG. 1, loading system 10 includes a reconditioner 12 to recondition used build material powder, a conveyor 14 to convey used build material powder to reconditioner 12, a dispenser 16 to dispense reconditioned build material powder into a supply receptacle, and a compactor 18 to compact powder in the receptacle.

System 10 also includes a controller 20 operatively connected to reconditioner 12, conveyor 14, dispenser 16, and compactor 18. Controller 20 includes the programming, processing and associated memory resources, and the other electronic circuitry and components to control the operative elements of system 10. Controller 20 may include distinct control elements for individual system components. Controller 20 in FIG. 1 includes a processor 22 and a computer readable medium 24 with system control instructions 26 operatively connected to processor 22. System control instructions 26 represent programming that enables controller 20 to control reconditioner 12 and conveyor 14 during reconditioning and to control dispenser 16 and compactor 18 during loading.

Reconditioner 12 includes a container 28 and a heater 30 operatively connected to container 28. Heater 30 heats powder in container 28 to a temperature high enough to burn unwanted residue from used build material powder in container 28 to form reconditioned build material powder. Conveyor 14 conveys used build material powder to reconditioner container 28 from a depowdering station or other source of used powder. Dispenser 14 dispenses reconditioned powder from container 28 into a supply receptacle for a 3D printer where it is compacted by compactor 18 to the desired level. The functions of heater 30, conveyor 14, dispenser 16, and compactor 18 may be controlled and coordinated, for example, at the direction of processor 22 executing instructions 26 on controller 20.

FIG. 2 illustrates an example system 32 for recycling build material powder for a 3D printer. Referring to FIG. 2, recycling system 32 includes a depowdering station 34, a loading station 36, and a conveyor 14 that conveys used build material powder from depowdering station 34 to loading station 36. Depowdering station 34 includes a depowdering chamber 38 and a device 40 to remove build material powder from a printed object in depowdering chamber 38, to form used build material powder. Loading station 36 includes a reconditioner 12 and a dispenser 16 operatively connected to reconditioner 12 to dispense reconditioned build material powder to a supply receptacle for a 3D printer. Conveyor 14 may be located at the depowdering station, at the loading station, or somewhere between the depowdering station and the loading station. While it is expected that conveyor 14 will usually be implemented as a pump, auger, or other suitable powered conveyor, a gravity conveyor could be used.

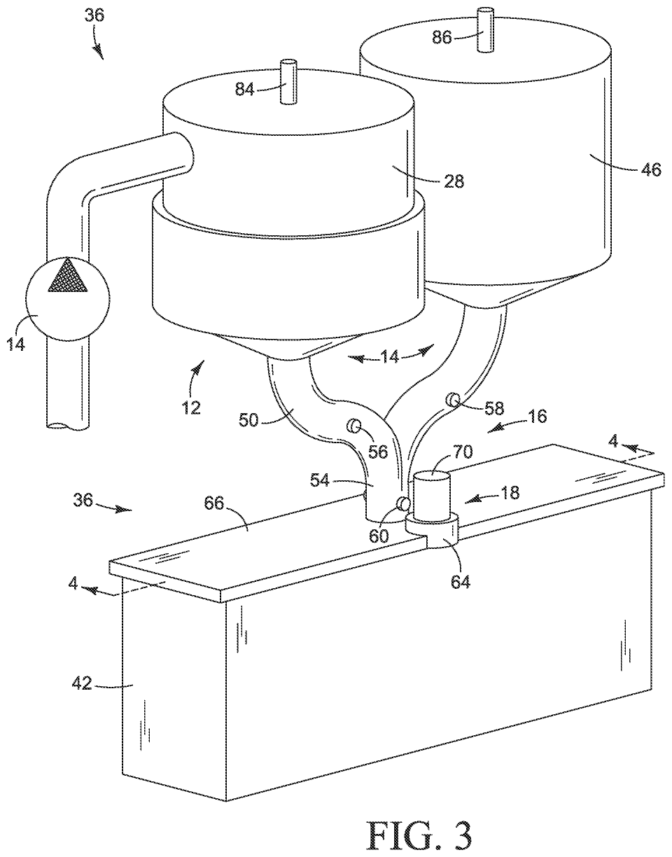

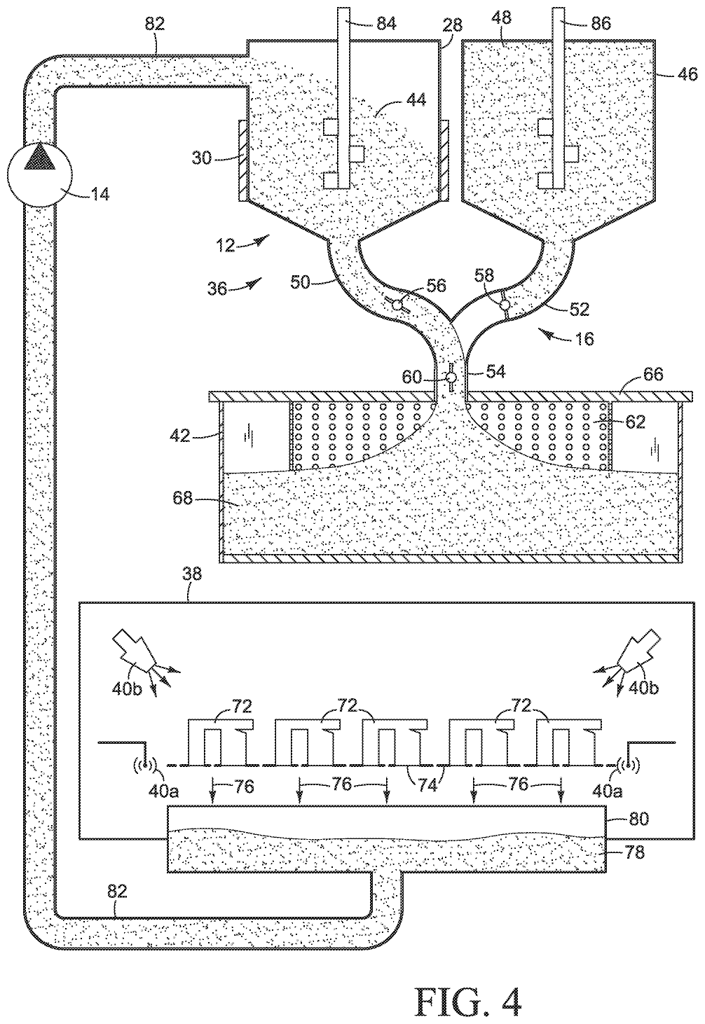

FIG. 3 illustrates an example loading station 36 for loading build material powder into a supply receptacle 42 for a 3D printer. FIG. 4 illustrates a recycling system 32 that includes a depowdering station 34, and a loading station 36 from FIG. 3. The section view of loading station 36 in FIG. 4 is taken along the line 4-4 in FIG. 3.

Referring to FIGS. 3 and 4, loading station 36 includes a dispenser 16, a reconditioner 12 with a container 28 to hold reconditioned build material powder 44, and a container 46 to hold fresh build material powder 48. In this example, dispenser 16 includes containers 28 and 46, conduits 50, 52, and 54, and valves 56, 58, and 60. Reconditioned powder 44 is dispensed from container 28 through conduit 50 and valve 56. Fresh powder 48 is dispensed from container 46 through conduit 52 and valve 58. Both powders 44 and 48 may be mixed in and are loaded into a supply receptacle 42 through a common conduit 54 and valve 60. Valves 56-60 are opened and closed selectively to dispense the desired mix and volume of powders 44, 48 into receptacle 42, for example at the direction of a system controller 20 shown in FIG. 1.

Loading station 36 also includes a compactor 18. Compactor 18 includes a movable compaction element 62 (FIG. 4) and an actuator 64 (FIG. 3) operatively connected to element 62. Actuator 64 controls the movement of compaction element 62, for example at the direction of a system controller 20 shown in FIG. 1. In the example shown in FIGS. 3 and 4, compaction element 62 is implemented as a screen mounted to the underside of a base 66, so that screen 62 extends down in to powder 68 in supply receptacle 42, and actuator 64 is implemented as a motor driven vibrator. Vibrator 64 vibrates base 66 and thus screen 62 at the urging of a motor 70. The movement of screen 62 causes powder 68 to settle, become more compact, and flattens the top surface of powder 68. Other configurations for a compactor 18 are possible. For example, one or multiple actuators 64 could be used to move a corresponding one or multiple blades or other compactor elements 62 up and down and/or side to side to compact and distribute powder 68 in supply receptacle 42.

Referring to FIG. 4, green parts or other printed objects 72 are supported on a platform, belt, turn-table or other support 74 in a depowdering chamber 38 at depowdering station 34. Objects 72 on support 74 are housed in depowdering chamber 38 along with the depowdering device(s) which, in this example, include a vibrators 40a to vibrate objects 72 and gas blasters 40b to blow air or another gas at objects 72. An air flow may be created generally in chamber 38, as indicated by arrows 76, to remove used powder 78 to a collection tank 80 for recycling. Also, a vacuum hose (not shown) may be used as a depowdering device to suck powder away from objects 72 in addition to, or as an alternative to, a generalized vacuum. The depowdering devices in chamber 38 may be operated automatically and/or manually. Objects 72 may be rotated by or on support 74 to more effectively present each object 72 to the depowdering devices.

In the example shown in FIGS. 3 and 4, conveyor 14 is implemented as a pump that pumps used build material powder 78 from tank 80 to reconditioning container 28 through a hose or other suitable conduit 82. Although pump 14 is between tank 80 and container 28 in this example, pump 14 may be placed at any location suitable for pumping used powder 78 to container 28. Pump 14 may be separate from loading station 36 and depowdering station 34, or pump 14 may be integral to loading station 36 or depowdering station 34. The intake and/or discharge of conduit 82 may be detachable from tank 80 and container 28, respectively. In an example, a flexible conduit 82 includes a portable intake that a user can manually insert into tank 80 to pump powder 78 to container 28. In an example, tank 80 is removable from depowdering chamber 38 for pumping powder 78 to container 28, for example using a portable intake to conduit 82.

Reconditioner 12 may also include a stirrer 84 in reconditioning container 28. Stirring powder 44 in container 28 during heating helps heat powder 44 more evenly to speed reconditioning. A stirrer 86 may be used to stir fresh powder 48 in container 46. Stirrers 84 and 86 inhibit clumping in powders 44, 48 for better flow into and through conduits 50-56 to supply receptacle 42.

In the example shown in FIGS. 3 and 4, heater 30 includes a thermal sleeve surrounding reconditioning container 28. However, any suitable heater 30 may be used. For example, hot oil or another heating element may be incorporated into stirrer 84 to heat powder 44. For another example, hot air may be introduced into container 28 to heat powder 44.

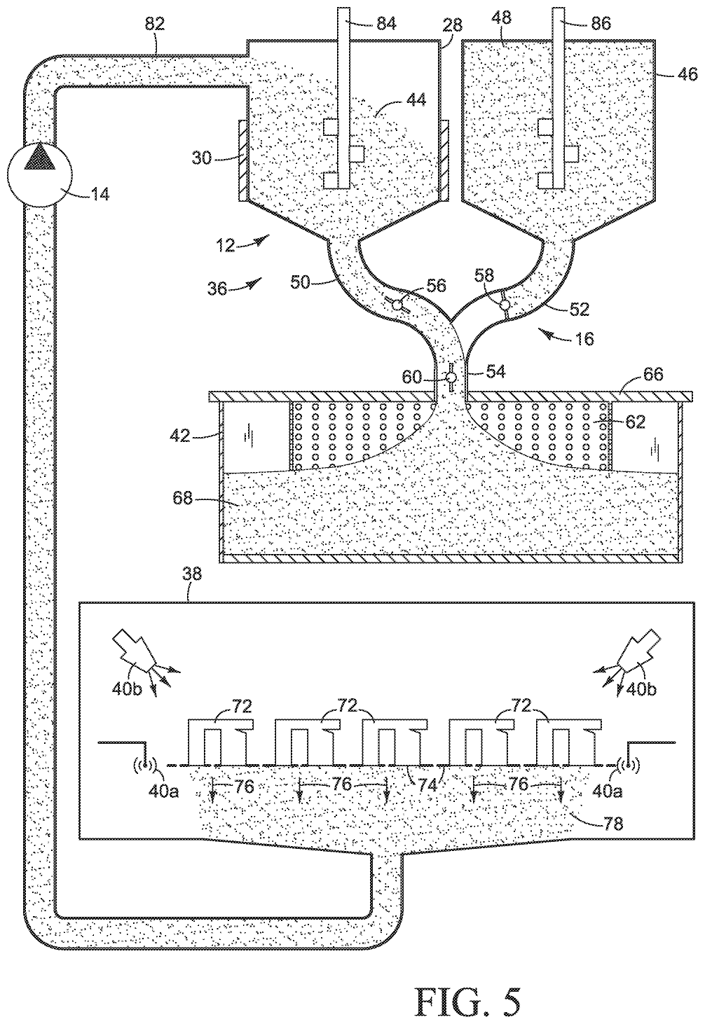

FIG. 5 illustrates another example recycling system 32, in which used build material powder 78 is pumped directly out of depowdering chamber 38 to reconditioning container 28 as the powder is removed from objects 72, without first being collected in a tank 80 in FIG. 4. In this example, conveyor pump 82 may be used to supply vacuum 76 in depowdering chamber 38 to draw used powder 78 away from objects 72.

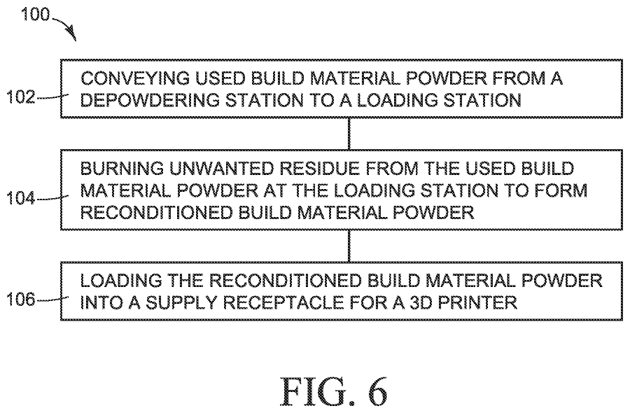

FIG. 6 illustrates an example process 100 for loading a build material powder supply receptacle for a 3D printer, such as might be implemented by a processor 22 executing instructions 26 on controller 20 in FIG. 1. Referring to FIG. 6, loading process 100 includes conveying used build material powder from a depowdering station to a loading station (block 102), burning unwanted residue from the used build material powder at the loading station, to form reconditioned build material powder (block 104), and loading the reconditioned build material powder into a supply receptacle for a 3D printer (block 106). Conveying used powder at block 102 may be implemented, for example, with pump 14 pumping powder 78 from depowdering chamber 38 to reconditioning container 28 in FIGS. 4 and 5. Burning unwanted residue at block 104 may be implemented, for example, with heater 30 heating powder 44 in container 28 in FIGS. 4 and 5 to a burn temperature. Loading reconditioned powder at block 106 may be implemented, for example, by dispensing reconditioned powder 44 through conduits 50 and 54 to supply receptacle 42 in FIGS. 4 and 5.

Used powder may be conveyed directly from the depowdering station to a reconditioning container at the loading station, for example as shown in FIGS. 4 and 5, or used powder may be conveyed to a holding unit separate from the depowdering station and then conveyed from the holding unit to a reconditioning container at the loading station. Used powder may be accumulated at the depowdering station and then conveyed to the reconditioning container at the loading station, for example as shown in FIG. 4, or used powder may be conveyed to the reconditioning container at the loading station as the powder is removed from the printed objects, for example as shown in FIG. 5.

The burn temperature used during reconditioning should be hot enough to burn unwanted residue but not so hot as to sinter or otherwise fuse the build material particles. While the burn temperature will vary depending on the type of powder and residue as well as the heating environment, a stainless steel build material powder commonly used to print green parts may be heated to 240° C.-270° C. in air under atmospheric conditions to burn off water based binder residue without sintering the powder.

As noted at the beginning of this Description, the examples shown in the figures and described above illustrate but do not limit the scope of the patent, which is defined in the following Claims.

“A” and “an” as used in the Claims means one or more. For example, “a heater” means one or more heaters and reference back to “the heater” means the one or more heaters.

1. A system for loading a build material powder supply receptacle for a 3D printer, the system comprising:
a reconditioner comprising a container and a heater to burn unwanted residue from used build material powder in the container, to form reconditioned build material powder;
a conveyor operatively connected to the reconditioner to convey used build material powder to the container; and
a dispenser operatively connected to the reconditioner to dispense reconditioned build material powder from the container into the supply receptacle.

2. The system of claim 1, comprising a controller operatively connected to the heater and the conveyor, the controller programmed to:
control the conveyor to convey used build material powder to the container; and
control the heater to heat used build material powder in the container to a temperature high enough to burn unwanted residue, to form the reconditioned build material powder.

3. The system of claim 1, wherein the reconditioner comprises a stirrer to stir heated build material powder in the container.

4. The system of claim 3, wherein the reconditioner and the dispenser are parts of the dispenser.

5. The system of claim 1, comprising a compactor to compact build material powder in the supply receptacle.

6. The system of claim 1, wherein the conveyor comprises a pump to pump used build material powder to the container.

7. A system for recycling build material powder for a 3D printer, comprising:
a depowdering station comprising:
a depowdering chamber; and
a device to remove build material powder from a printed object in the depowdering chamber, to form used build material powder; and
a loading station comprising:
a reconditioner comprising a container and a heater to burn unwanted residue from used build material powder in the container, to form reconditioned build material powder; and
a dispenser operatively connected to the reconditioner to dispense reconditioned build material powder from the container into a supply receptacle; and
a conveyor operatively connected to the reconditioner to convey used build material powder from the depowdering station to the container.

8. The system of claim 7, wherein:
the depowdering station includes a tank operatively connected to the depowdering chamber to collect used build material powder; and
the conveyor is operatively connected between the tank and the container to convey used build material powder from the tank to the container.

9. The system of claim 7, wherein the conveyor comprises a pump that simultaneously sucks used build material powder away from printed objects in the depowdering chamber and conveys the used build material powder to the container.

10. The system of claim 7, comprising a controller operatively connected to the heater and the conveyor, the controller programmed to:
control the conveyor to convey used build material powder to the container; and
control the heater to heat used build material powder in the container to a temperature high enough to burn unwanted residue, to form the reconditioned build material powder.

11. The system of claim 7, wherein the reconditioner comprises a stirrer to stir heated build material powder in the container.

12-20. (canceled)

21. A system for recycling build material powder for a 3D printer, comprising:
a means for conveying used build material powder from a depowdering station to a loading station;
a means for burning unwanted residue from the used build material powder at the loading station to form reconditioned build material powder; and
a means for loading the reconditioned build material powder into a supply receptacle for a 3D printer.

22. The system of claim 21, wherein the means for conveying comprises a means for conveying the used build material powder directly from the depowdering station to the loading station.

23. The system of claim 22, comprising a means for accumulating used build material powder at the depowdering station and wherein the means for conveying comprises a means for conveying accumulated used build material powder directly from the depowdering station to the loading station.

24. The system of claim 21, wherein the used build material powder comprises used metal build material powder and the means for burning comprises a means for burning binder residue from the used metal build material powder.

25. The system of claim 24, wherein the means for burning comprises a means for heating the used metal build material powder to 240° C.-270° C.
